(19) United States
(12) Patent Application Publication
(10) Pub. No.: US 2014/0157635 A1
(43) Pub. Date: Jun. 12, 2014

(54) CONICAL PIN AND BEARING ASSEMBLY

(71) Applicant: CATERPILLAR INC., Peoria, IL (US)

(72) Inventor: Richard J. La Reau, Murphysboro, IL (US)

(73) Assignee: Caterpillar Inc., Peoria, IL (US)

(21) Appl. No.: 13/710,542

(22) Filed: Dec. 11, 2012

(51) Int. Cl. E02F 3/407; F16C 11/04

(52) U.S. Cl. CPC E02F 3/4075; F16C 11/04
USPC 37/443; 403/161; 29/525.02

(57) ABSTRACT

A pin and bearing assembly including a pair of pins, each pin having a frustoconical portion, a pair of sleeve bearings configured to rotate relative to the pair of pins, a pair of rings configured to couple the pair of sleeve bearings to a hub, and a thru rod having a nut on a first end wherein when the nut is tightened a compressive force is applied to the pair of pins and pair of sleeve bearings.

### TECHNICAL FIELD

This disclosure relates generally to pin and bearing assemblies for coupling two rotatable components. More particularly, it relates to conical pin and bearing assemblies that may be used to couple a dipper door to a bucket.

### BACKGROUND

Pinned joints are used in machines to couple two pieces that move relative to each other. In some mining equipment a dipper includes a bucket and a door, the door being movable relative to the bucket. Dippers are under near-constant use in a mine. In addition, dipper and dipper components handle heavy loads. It is anticipated that a certain amount of wear will occur on joints that couple two moving pieces together. A pinned joint is used to couple the bucket to the door. In some prior art embodiments these pinned joints may have short life spans this requiring maintenance and/or replacement on a regular basis. It is desirable to extend the life span of pinned joints to reduce maintenance requirements and to extend the life span of the joint.

U.S. Pat. No. 3,433,502 discloses an articulated vehicle having an improved hinge means for pivotally interconnecting the articulated sections of the vehicle. Specifically, the '502 Patent discloses a means for compensating for wear between bearing surfaces of articulated sections of a vehicle without continuous replacement of bearings after short periods of use.

### SUMMARY OF THE INVENTION

In one embodiment the disclosure provides a pin and bearing assembly including a pair of pins configured to cooperate with a hub, each pin including a frustoconical end and a cylindrical aperture through each pin centered on a major axis. The disclosure further includes a rod positioned through the apertures along the major axis connecting the pins and the hub.

In an alternative embodiment the disclosure provides a method of coupling a hub to a component including placing a first pin into a first opening disposed on the hub and placing a second pin into a second opening disposed on the hub. The method further involves placing a threaded rod through a first aperture disposed on the first pin, a second aperture disposed on the second pin and a throughway disposed on the hub. The method also involves placing a bolt on a first end of the threaded rod and tightening the bolt on the first end of the threaded rod to apply a compressive force on the first pin, second pin and the hub.

In yet another alternative embodiment the disclosure provides a dipper having a bucket having four sides, an opening, and a door pivotally coupled to the bucket, the door configured to selectively cover the opening. The dipper further has a linkage coupled to the door and the bucket, the linkage including a hub and a pair of pins configured to cooperate with the hub, each pin including a frustoconical end and a cylindrical aperture through each pin centered on a major axis. The dipper also has a threaded rod positioned through the apertures along the major axis connecting the pins and the hub.

### BRIEF DESCRIPTION OF THE DRAWINGS

FIG. 1 is a perspective view of a dipper.

FIG. 2 is an exploded view of a hub and pin and bearing assembly.

FIG. 3 is a perspective view of a sleeve bearing used in the pin and bearing assembly of FIG. 2.

FIG. 4 is a perspective view of a ring used in the pin and bearing assembly of FIG. 2.

FIG. 5 is a perspective view of a pin used in the pin and bearing assembly of FIG. 2.

FIG. 6 is a section view of the hub, pin and bearing assembly illustrated in FIG. 2.

### DETAILED DESCRIPTION

A machine may have two components that need to be coupled together while still allowing the components to move relative to each other. An example of the machine is a rope shovel, hydraulic shovel, excavator, backhoe, material handler and the like. The machine includes a dipper 10 which is used to hold dirt or ore.

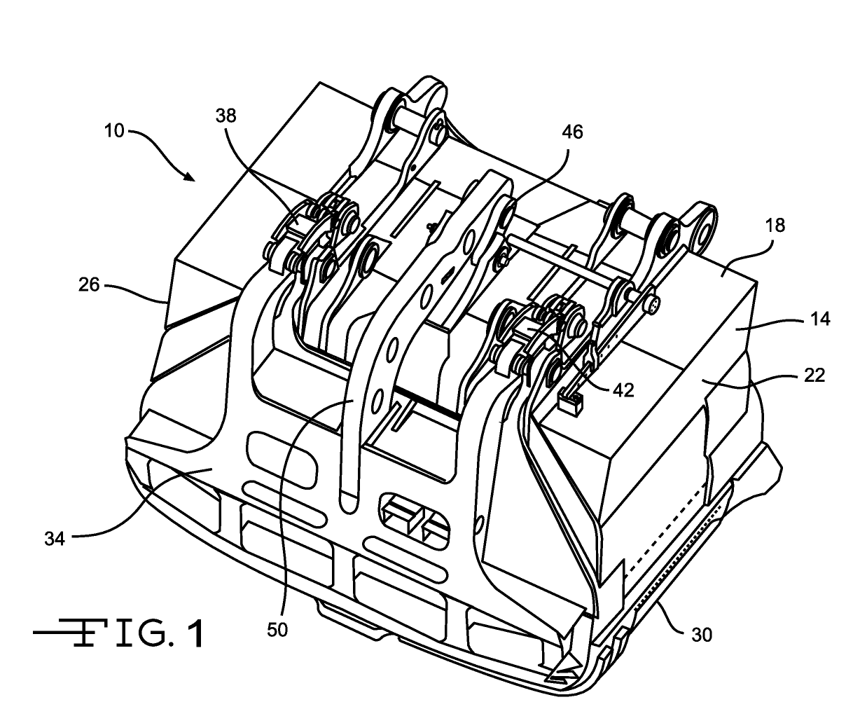

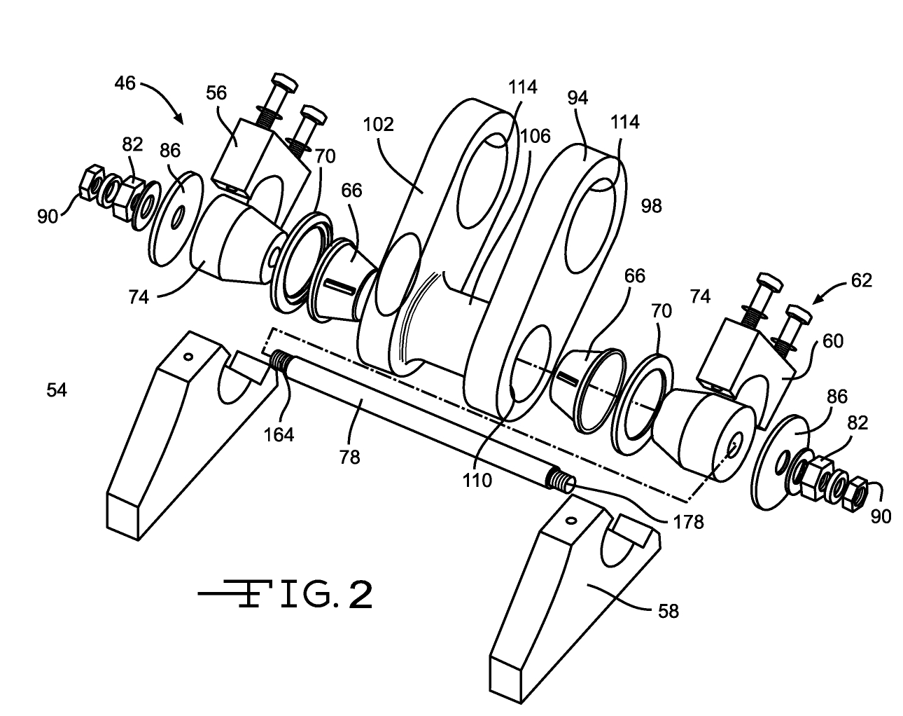

The dipper 10 illustrated in FIG. 1 includes a bucket 14 having a first wall 18, a second wall 22, a third wall 26, a fourth wall 30, and a door 34. The door 34 selectively covers an opening on the bucket 14 when it is in a first position (illustrated in FIG. 1). The bucket 14 and door 34 cooperate to form a container for holding dirt, ore or the like. The door 34 may be moved to a second position to allow the dirt or ore to exit the bucket 14 through the opening. The door 34 is coupled to the bucket 14 at a first joint 38 and a second joint 42. A third joint 46 couples a linkage 50 to the door 34 and the bucket 14. In the illustrated embodiment first and second mounting blocks 54, 58, best seen in FIG. 2, are coupled to the first wall 18 and assist in coupling the third joint 46 to the bucket 14. The illustrated embodiment includes first and second coupling blocks 56, 60 to assist in coupling the third joint 46 to the bucket 14. In an alternative embodiment the first and second mounting blocks 54, 58 are integral to the bucket 14. The linkage 50 serves to selectively keep the door 34 in the first position.

The third joint 46 includes a pin and bearing assembly 62. The pin and bearing assembly 62 will be described herein as used in the third joint 46, but the pin and bearing assembly 62 may be used with the first joint 38, the second joint 42 or other joints not described herein such as a hinge.

The pin and bearing assembly 62 includes two sleeve bearings 66, two rings 70, two pins 74, a thru rod 78, two nuts 82, two washers 86, two lock nuts 90 and a hub 94.

The hub 94, as best seen in FIG. 2, includes a first arm 98, a second arm 102 and a connecting arm 106 disposed between the first arm 98 and second arm 102, the connecting arm 106 coupling the first and second arm 98, 102 together. Each of the first arm 98 and second arm 102 includes first and second openings 110, 114 disposed thereon. The connecting arm 106 includes an opening 118 disposed in the interior of the connecting arm 106, the opening 118 passing entirely through the connecting arm 106 as best illustrated in section view in FIG. 6. The first opening 110 of the first arm 98, the first opening 110 of the second arm 102 and the opening 118 of the connecting arm 106 are each centered on a major axis 122 (illustrated in FIG. 6).

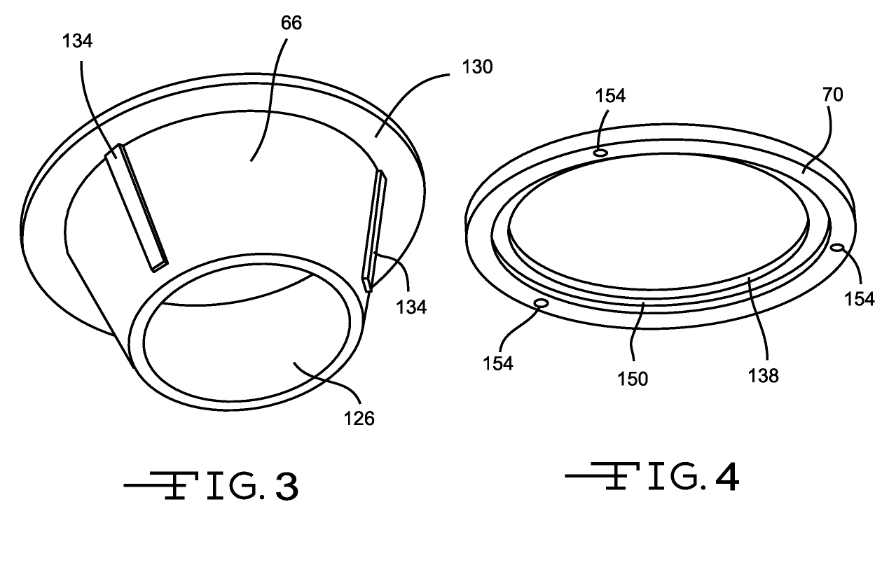

The pin and bearing assembly 62 includes two sleeve bearings 66 as seen in FIG. 2, the two sleeve bearings 66 being substantially identical to one another. The sleeve bearing 66, illustrated in perspective view in FIG. 3, is generally of a frustoconical shape and includes a frustoconical aperture 126 in an interior portion of the sleeve bearing 66. The sleeve bearing 66 also includes a shoulder 130 which is sized and configured to cooperate with the hub 94 to inhibit the sleeve bearing 66 from passing too far into an interior portion of the hub 94. The sleeve bearing 66 also includes raised portions 134 thereon, the raised portion cooperating with an indentation (not shown) in the hub 94 to inhibit the sleeve bearing 66 from rotating with respect to the hub 94.

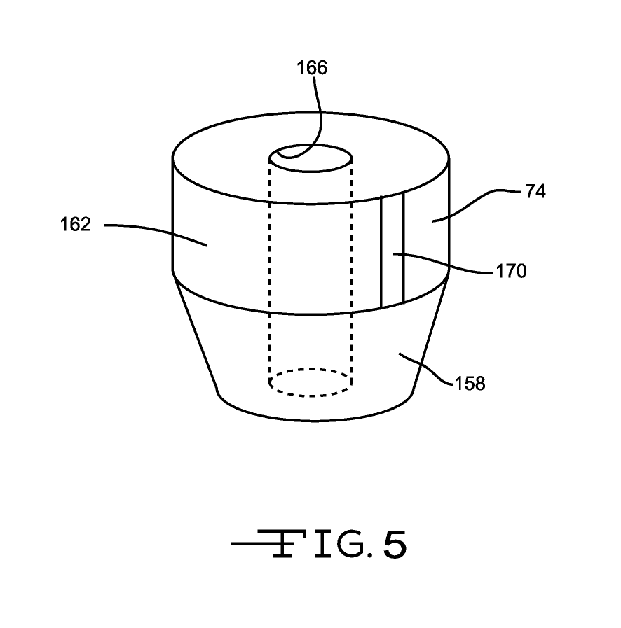

The pin and bearing assembly 62 includes two rings 70 as seen in FIG. 2, the rings 70 being substantially identical to one another. The ring 70, illustrated in perspective view in FIG. 4, is circular and includes a circular aperture 138. A first side 142 of the ring 70 is substantially flat, while a second side 146 includes a stepped portion 150. The stepped portion 150 is sized and configured to interface with the sleeve bearing 66 to inhibit the sleeve bearing 66 from separating from the hub 94. In the illustrated embodiment the ring 70 includes three holes 154 disposed thereon, the 3 holes 154 serving to receive a screw, bolt or the like to couple the ring 70 to the hub 94.

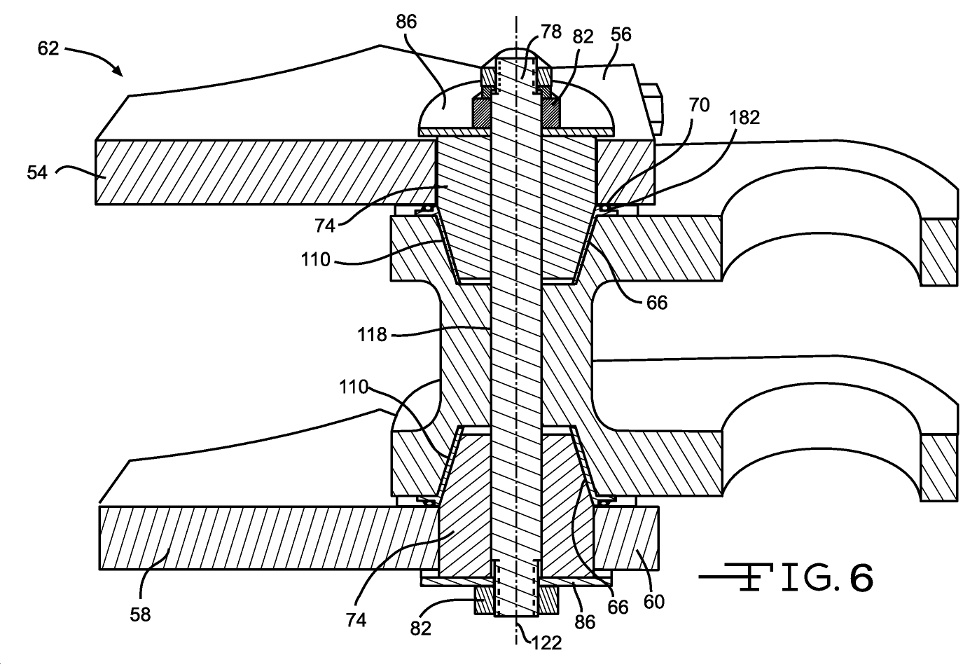

The pin and bearing assembly 62 includes two pins 74 as seen in FIG. 2, the pins 74 being substantially identical to one another. The pin 74, illustrated in perspective view in FIG. 5, includes a frustoconical portion 158 and a cylindrical portion 162. A cylindrical aperture 166 passes through both the frustoconical and cylindrical portions 158, 162. The frustoconical portion 158 is sized and configured to interface with the sleeve bearing 66 such that the pin 74 is able to rotate with respect to the sleeve bearing 66. The length of the pin 74 is such that when the pin and bearing assembly 62 is assembled a part of the cylindrical portion 162 of the pin 74 extends past the first and second mounting blocks 54, 58 and first and second coupling blocks 56, 60, as best seen in FIG. 6.

In one embodiment the pin 74 has a flat surface 170 disposed on an outer part of the cylindrical portion 162, the flat surface 170 interfacing with a surface of at least one of the mounting blocks 54, 58 or coupling blocks 56, 60 to inhibit rotation of the pin 74 with respect to the first and second mounting blocks 54, 58. In another embodiment the pin 74 has a raised surface disposed on an outer part of the cylindrical portion 162, the raised surface interfacing with an indentation on at least one of at least one of the mounting blocks 54, 58 or coupling blocks 56, 60 to inhibit rotation of the pin 74 with respect to the first and second mounting blocks 54, 58. In yet another embodiment the pin 74 includes an indentation disposed on an outer part of the cylindrical portion 162. A corresponding indentation is disposed on at least one of at least one of the mounting blocks 54, 58 or coupling blocks 56, 60, the indentations on the pin 74 and the mounting blocks 54, 58 being sized and configured to receive a key, the key serving to inhibit rotation of the pin 74 with respect to the first and second mounting blocks 54, 58.

The pin and bearing assembly 62 also includes the thru rod 78, two nuts 82, two washers 86 and two lock nuts 90. Some embodiments may include additional washers 86. The thru rod 78 is cylindrical and includes first and second ends 174, 178. In the illustrated embodiments the first and second ends 174, 178 have threads disposed thereon. In an alternative embodiment, the thru rod 78 may be a bolt having a head on the first end 174 and threads disposed on the second end 178. The nuts 82 are sized and configured to interface with the threads disposed on the thru rod 78. The washers 86 are disposed on the first and second ends 174, 178 of the thru rod 78 between the nut 82 and the first and second mounting blocks 54, 58. Locks nuts 90 are sized and configured to interface with the threads disposed on the thru rod 78.

The pin and bearing assembly 62 is illustrated in section view in FIG. 6. The sleeve bearings 66 are disposed in the first openings 110 of the first and second arms 98, 102 of the hub 94, the sleeve bearings 66 being centered on the major axis 122. The rings 70 are disposed next to the sleeve bearings 66 and the hub 94, the rings 70 being centered on the major axis 122. Screws, bolts or the like couple the rings 70 to the hub 94. A gasket 182 is disposed between the sleeve bearing 66 and the mounting block 54. The frustoconical portion 158 of the pins 74 are also disposed in the first openings 110 of the first and second arms 98, 102 of the hub 94, the pins 74 being centered on the major axis 122. The sleeve bearings 66 are disposed proximate to the hub 94, while the pins 74 are proximate to the sleeve bearings 66. The first and second mounting blocks 54, 58 cooperate to fix the pins 74 to the bucket 14. The thru rod 78 is disposed on the major axis 122, the thru rod 78 passing through the pins 74, sleeve bearings 66 and hub 94. Washers 86 are disposed on the first and second end 174, 178 of the thru rod 78. Nuts 82 are then disposed on the first and second end 174, 178 of the thru rod 78. As the nuts 82 are tightened a compressive force is applied to the pin and bearing assembly 62.

A method of coupling the hub 94 to a component, such as the bucket 14, using the pin and bearing assembly 62 will now be described. First, one sleeve bearing 66 is placed into the first opening 110 of the first arm 98. Next another sleeve bearing 66 is placed into the first opening 110 of the second arm 102. After that two rings 70 are placed proximate to the sleeve bearings 66 and coupled to the hub 94 using screws, bolts or the like. Next two pins 74 are placed proximate to the sleeve bearings 66, one pin 74 being placed proximate to each sleeve bearing 66. At that point the pins 74 may be coupled to the bucket 14 by coupling the mounting blocks 54, 58 to the coupling blocks 56, 60. In the next step the thru rod 78 is placed through the hub 94, sleeve bearings 66 and pins 74, the thru rod 78 being centered along the major axis 122. Washers 86 are then placed on the first and second end 174, 178 of the thru rod 78. In the next step nuts 82 are tightened onto the threads disposed on the first and second end 174, 178. As the nuts 82 are tightened, a compressive force is applied to the pin and bearing assembly 62.

### INDUSTRIAL APPLICABILITY

The present disclosure is applicable to pin and bearing assemblies 62 for any oscillatory joint arrangement between relatively moveable components. Exemplary applications include the dipper door 34 and bucket 14 of a mining shovel, a lift arm and end frame connection or a bucket and support arm connection of an end loader. The pin and bearing assembly 62 would also be suitable for other connections such as lift or tilt linkages.

The pin and bearing assembly 62 of the present disclosure is useful because it allows the dipper door 34 and bucket 14 to rotate relative to each other with little or no wear on the dipper door 34 and bucket 14. Rather, the pin and bearing assembly 62 wears when the dipper door 34 and bucket 14 move relative to each other. The design of the pin and bearing assembly 62 allows for the pin and bearing assembly 62 to be tightened when at least one of the pin 74 and the sleeve bearing 66 is worn causing the joint between the dipper door 34 and bucket 14 to be loose. The pin and bearing assembly 62 may be adjusted simply by tightening one or both of the nuts 82 coupled to the thru rod 78. The adjustability of the pin and bearing assembly 62 also results in longer life for the pin and bearing assembly 62 because it may be adjusted as it wears, thus resulting in reduced maintenance and parts costs. The ultimate result of the disclosure described herein will be less downtime for the dipper 10, increased service life, and more profitability over the course of its operation.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A pin and bearing assembly comprising:
a pair of pins configured to cooperate with a hub, each pin including a frustoconical end and a cylindrical aperture through each pin centered on a major axis; and
a rod positioned through the apertures along the major axis connecting the pins and the hub.

2. The pin and bearing assembly of claim 1 further comprising a pair of frustoconical sleeve bearings sized and configured to be disposed on the pair of pins and cooperate with the hub, each sleeve bearing being centered on the major axis.

3. The pin and bearing assembly of claim 2 wherein at least one of the pair of pins includes a flat surface disposed thereon to inhibit rotation of the pin with respect to a mounting block.

4. The pin and bearing assembly of claim 2 further comprising a nut disposed on a first end of the thru rod, wherein when the nut is tightened a compressive force is applied to the pair of pins.

5. The pin and bearing assembly of claim 2 wherein each of the pair of sleeve bearings includes a raised portion thereon to inhibit rotation of the bearing with respect to the hub.

6. The pin and bearing assembly of claim 2 wherein each of the pair of sleeve bearings includes a shoulder.

7. The pin and bearing assembly of claim 6 further comprising a pair of rings, each ring having a stepped portion thereon, the stepped portion of each ring being disposed proximate to the shoulder, the shoulder and ring cooperating to couple the bearing to the hub.

8. A method of coupling a hub to a component comprising:
placing a first pin into a first opening disposed on the hub;
placing a second pin into a second opening disposed on the hub;
placing a threaded rod through a first aperture disposed on the first pin, a second aperture disposed on the second pin and a throughway disposed on the hub;
placing a bolt on a first end of the threaded rod;
tightening the bolt on the first end of the threaded rod to apply a compressive force on the first pin, second pin and the hub.

9. The method of claim 8 wherein the first pin and the second pin each include a frustoconical end.

10. The method of claim 8 further comprising coupling the first pin to the component with a first mounting block.

11. The method of claim 10 further comprising coupling the second pin to the component with a second mounting block.

12. The method of claim 8 further comprising placing a frustoconical sleeve bearing between the hub and the first pin.

13. The method of claim 12 further comprising coupling the sleeve bearing to the hub with a ring having a stepped portion thereon.

14. A dipper comprising:
a bucket having four sides and an opening;
a door pivotally coupled to the bucket, the door configured to selectively cover the opening;
a linkage coupled to the door and the bucket, the linkage including a hub;
a pair of pins configured to cooperate with the hub, each pin including a frustoconical end and a cylindrical aperture through each pin centered on a major axis; and
a threaded rod positioned through the apertures along the major axis connecting the pins and the hub.

15. The dipper of claim 14 further comprising a pair of frustoconical sleeve bearings sized and configured to be disposed on the pair of pins and cooperate with the hub.

16. The dipper of claim 15 wherein at least one of the pair of pins includes a flat surface disposed thereon to inhibit rotation of the pin with respect to a mounting block.

17. The dipper of claim 15 wherein at least one of the pair of sleeve bearings includes a raised portion thereon to inhibit rotation of the bearing with respect to the hub.

18. The dipper of claim 15 wherein each of the pair of sleeve bearings includes a shoulder.

19. The dipper of claim 18 further comprising a pair of rings, each ring having a stepped portion thereon, the stepped portion of each ring being disposed proximate to the shoulder, the shoulder and ring cooperating to couple the bearing to the hub.

20. The dipper of claim 14 further comprising a bolt coupled to the threaded rod, the bolt being tightened to apply a compressive force to the hub and the pair of pins.
